(19) United States
(12) Patent Application Publication
(10) Pub. No.: US 2010/0012206 A1
(43) Pub. Date: Jan. 21, 2010

(54) Control unit for the supply of water-bearing household appliances

(75) Inventors: Edwin Bolduan, Berlin (DE); Horst Wiemer, Muenchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munich (DE)

(21) Appl. No.: 11/794,645

(22) PCT Filed: Dec. 2, 2005
(86) PCT No.: PCT/EP05/56427

§ 371 Date: Aug. 14, 2009

(30) Foreign Application Priority Data
Jan. 3, 2005 (DE) 10 2005 000 627.2

(51) Int. Cl. F16K 11/00

(52) U.S. Cl. 137/597

(57) ABSTRACT

A control unit for household appliances which are connected to a cold and hot water supply network (K and H). Said control unit comprises a mechanical actuator which can adjust the temperature of the mixed water from both of the water networks to a predetermined value in conjunction with a thermosensor and an intelligent evaluation system and is branched to various outlet lines at the same time as the mixed water flow. The adjusting element is embodied as a rotary valve or as a piston and is only displaced in one direction by means of the drive thereof. The outlet lines, which correspond to the program sequence, are successively controlled in the direction of displacement.

The invention relates to a control unit for water-bearing household appliances especially for automatic washing machines which are equipped with separate water connections for hot and cold water.

Compared to heating in individual appliances central hot water supply systems offer a more efficient method of heating water up to the required operating temperature. Connecting the household appliances to the hot water supply network both saves energy for heating the washing or rinsing liquid as well as shortening the duration of the program overall, since the time for heating the liquid up to the temperature specified by the program control unit can be significantly reduced. Reheating can be omitted completely if the water temperature in the hot water supply network is sufficiently high and the supply of cold and hot water is appropriately controlled. It goes without saying that a specific, more complex program design compared to conventional appliances with only one cold water connection is required for the additional hot water connection. More expensive than these programming changes and thereby more cost-intensive is adapting the design of the appliances to the changed water supply. Appliance manufacturers are now making efforts to provide users with the positive options of a hot water connection and simultaneously to offer such appliances at a reasonable price.

Mechanical control unit have already become known from commercially available household appliances which are equipped with two feeds for cold water and hot water and a drain for the mixed water and with a mechanical adjusting element which regulates the throughflow volumes of cold and hot water by continuously enlarging of reducing the two inlet openings. The mechanical adjusting element, in the form of a rotary valve, regulates the flows of water in the opposite direction, i.e. when the hot water inflow is increased the cold water supply is simultaneously restricted. The interior of the control unit is designed to support a rapid mixing of the inflowing water flows and a simple outflow of the mixed water. This mechanically controlled mixed water feed makes a continuous and thereby fast inflow of water possible. In conjunction with a drive motor with reversible drive the mixed water can be regulated to any temperature of which the value lies between that of the cold and the hot water. The outlay for this type of control is however relatively high, especially for driving the adjusting element.

A distribution of the water flow following on from the control unit can be undertaken in the normal manner for washing machines by branching into two inlet channels controlled by magnetic valves and connecting these to a water switch with three outputs (DE 2 232 020 A). The three outputs are each assigned to a container in which detergents or cleaning products are held separately for the pre-wash, main wash and rinse. DE 197 25 745 A1 describes a water switch with a motor-driven distribution arm, in which only one feed line and only one control valve for the supply are present. The described combination of control unit and distributor requires four valves or three valves and a control motor which must be switched or controlled separately. A greater disadvantage than the complex control is the plurality of individual parts, the means for attaching them and a significant number of connections which require an increased installation effort and can cause faults and leaks during operation.

The underlying object of the invention, for water-bearing household appliances with separate cold and hot water connections is to specify a control device, with the aid of which a continuous feed of mixed water at a temperature which can be adjusted to any level, as well as a branch for the different program sections pre-wash, main wash and rinse, can be implemented. It is also the object of the invention to restrict to a minimum the number of components which make up the system, which are necessary to attach it and connect it to the water-bearing system of the washing machine.

According to the invention this object is achieved by the features set down in the main claim. Advantageous embodiments of the invention are specified in the subclaims.

The inventive control device features a mechanical control unit able to be actuated by a rotary movement or a lifting movement, via which the two feed lines for cold and hot water can be continuously and opened or closed in opposite directions, as well as a number of drain lines which can be released according to the program section assigned in each case for draining off the mixed water. In accordance with the invention the temperature of the mixed water is controlled and also distributed with just one module.

It is advantageous to install a thermosensor in the housing of the control unit, with which the temperature of the mixed water is recorded directly where the flows of water from the cold and hot water feed mix.

The inertia of the control system is reduced with this arrangement of a thermosensor. The control unit has only one active adjusting element which is only moved in one direction in the embodiment of the invention. This reduces the necessary adjusting effort, with a simple motor without drive reversal also being able to be used as the adjusting element. A further significant economic advantage is produced by the fact that the control unit allows the feed, the mixing and the distribution of the flows of water to be implemented with a single module. By comparison with known solutions this effects a significant reduction in the individual parts, the means for attaching them and the means for connecting them. This means that the manufacturing of the control unit is extraordinarily rational, in particular the effort involved in installation and providing spare parts is reduced. The reduction in the number of connection points needed also minimizes the danger of a leak, thus enhancing the operational safety of the washing machine as a whole.

The invention is explained in greater detail below by two exemplary embodiments. The associated drawings show

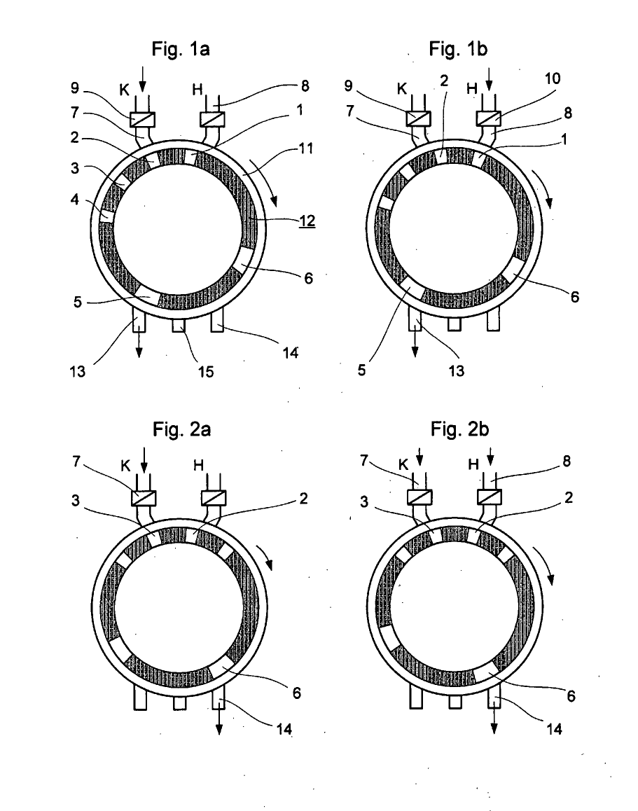

FIG. 1a to 3b: an inventively embodied control unit with rotary valve and

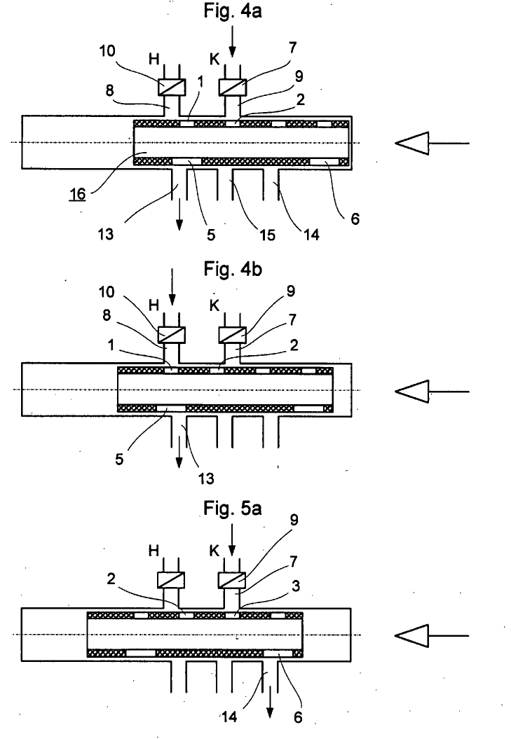

FIG. 4a to 6b: an inventively embodied control unit with piston valve.

The drawings show the inventive device in a flat cross-section in different operating states of significance for the program sequence, with the drawings 1a to 3b depicting an embodiment with rotary valve 12 as adjusting element and the drawings 4 to 6 an embodiment with piston valve 16 as adjusting element.

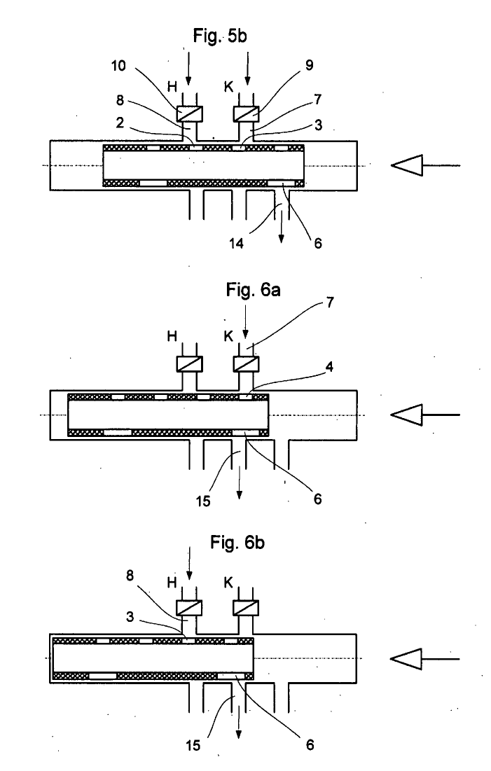

The same states are shown in the diagrams with piston valve, FIGS. 4a and 4b for pre-wash, FIGS. 5a and b for main wash and FIGS. 6a and b for the rinsing cycle. The following embodiments primarily relate to the preferred form of embodiment of the control with the rotary valve 12, but they also apply equally to the control with piston valve 16, so that there is no need to provide a description of its function.

The adjusting element 12 has a number of inlet openings 1 to 4 with the same dimensions, of which 2 openings always control the flow of incoming cold and hot water by changing the released cross-section of the feed lines 7 and 8, as well as two larger outlet openings 5, 6, which in the control area of the inlet lines 1 to 4 each release one or more drain lines 13, 14, 15. At the beginning of the washing program the rotary valve 12 in FIG. 1a is positioned so that with an opened magnetic valve 9 cold water flows in via the feed 7 and the inlet opening 2 into the rotary valve embodied as the mixing chamber 12 and can flow out via the outlet opening 5 and the drain line 13. The drain line 13 is connected to a detergent dispenser tray not shown in the diagram, which is loaded with the detergent provided for the pre-wash cycle. FIG. 1b depicts the state in which, after the rotary valve 12 is displaced in the direction of the arrow, the cold water line 7 is blocked and hot water can flow in via the feed line 8 and out via the drain line 13. In this case the hot water line is released via the inlet opening 1 and the drain line 13 remains opened via the outlet opening 5. Since the pre-wash program is generally run with cold water, this state has practically no role to play. To suppress the hot water feed entirely, the feed line 8 can be blocked by the magnetic valve 10.

FIG. 2a shows the starting position for the main wash cycle. Cold water can flow via the line 7 and the inlet opening 3 into the mixing chamber and flow out via the outlet opening 6 into the drain line 14 and be directed to the detergent dispenser tray for the main wash cycle. By rotating the rotary valve 12 the volume flow of the cold water is reduced and that of the hot water increased. FIG. 2b depicts the state in which the cold water feed line 7 is partly opened by the inlet opening 3 and the hot water feed line 8 partly opened by the inlet opening 2. By rotating the valve 12 to the right the hot water feed line 8 is opened further and the cold water feed line 7 is blocked to the same degree. The mixed water can be adjusted to any temperature lying in the range between the cold water temperature and the hot water temperature by the rotary movement of the valve 12. The drain line 114 remains open via the drain opening 6 for each intermediate setting of the valve 12, so that an always constant volume flow of mixed water flows out regardless of the temperature level set.

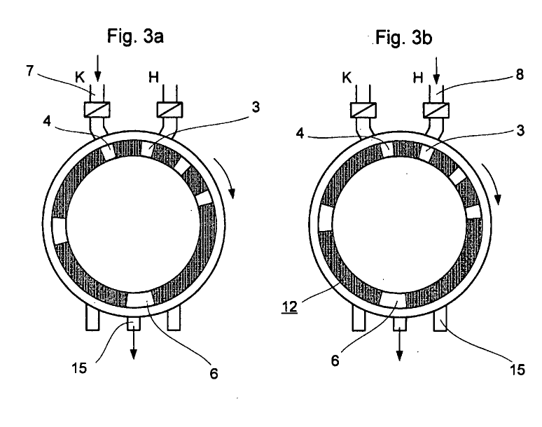

In a similar manner to the operating states depicted above, the settings of the valve 12 are shown in FIGS. 3a and 3b for the cold or hot water feed for the “rinsing” program section. As can be seen from the drawings, the cold water flow will be controlled by adjusting the opening 4 and the inflow of hot water controlled via the opening 3. The outflow occurs via opening 6 and line 15. This state is conceivable for the case in which the wash program is to be ended with rinsing and the last rinsing cycle is to be performed with hot water, which is of advantage for the level of residual moisture after spin drying. The construction of the control allows a constant temperature regulation for each program section in the same manner, which means that the room for maneuver as regards program design is expanded without additional effort.

The inventive solution presented allows the temperature of the incoming flow of water as well its distribution for activation of the different detergent chambers to be controlled by a single mechanical adjusting element. The magnetic valves 9, 10 only have an on/off switching function; they are of no significance for the actual temperature control. Over the entire washing process the adjusting elements 12, 16 are only moved in one direction, which means that the positions for the program sections pre-wash, main wash and rinse are arrived at chronologically in turn. After the program has run the rotary valve 12 is returned by further rotation to its starting position, with piston valve 16 this is done by a spring mechanism. Both embodiments make to with a drive without reversal of the direction of movement. The initial positions for the individual program section, in which only cold water is fed to the drain lines 13, 14, 15, lie at the same angle of rotation or the same spacing in relation to each other.

Likewise the angle of rotation or shift paths of adjustment elements 12 and 16 are always the same for the temperature control of the mixed water. This constructional measure means that the control effort for the inventive device is extraordinarily small.

In the exemplary embodiment shown the inventive control unit has three drain lines 13, 14, 15. This corresponds to the usual program division for washing machines and the associated usual storage of three different washing or cleaning products which are washed out of their storage compartments in the program sections and directed into the lie container. An expansion (also a reduction) of the number of drain lines is possible without any additional great effort. If one or more additional drain lines are created the number of inlet and outlet openings in adjustment element 12 or 16 must necessarily be increased. This can be done in a simple manner according to the same constructional features as described above.

1-5. (canceled)

6. A mechanical control unit for the supply of a water-bearing household appliance connected to a cold water and a hot water supply network, the control unit comprising:
a mechanically movable adjustment element having a number of inlet openings including opening widths and spacings from each other being the same and being dimensioned in relation to the arrangement of cold and hot water feed lines so that each two of the inlet openings can close and open the cold and hot water feed lines in opposite directions, and
the adjustment element having drain openings including opening widths and spacings from each other being dimensioned in relation to the arrangement drain lines and the inlet openings being dimensioned so that one of the drain lines is opened and this open position is retained with opened cold and hot water feed lines.

7. The control unit as claimed in claim 6, wherein the adjusting element is embodied as a valve which is guided in a cylindrical space and can be moved by means of a linear drive.

8. The control unit as claimed in claim 6, wherein the adjusting element is embodied as a rotary valve which is rotatably supported in a cylindrical or spherical housing and is able to be moved by means of a rotary drive.

9. The control unit as claimed in claim 6, wherein the adjusting elements are only able to be moved by their drives in one direction.

10. The control unit as claimed in claim 6, further comprising a thermosensor arranged in the housing which is connected via a measurement data line to an intelligent evaluation system which can generate control pulses to control the adjusting element as a function of the measurement data.
